(19) United States
(12) Patent Application Publication
(10) Pub. No.: US 2011/0046842 A1
(43) Pub. Date: Feb. 24, 2011

(54) SATELLITE ENABLED VEHICLE PROGNOSTIC AND DIAGNOSTIC SYSTEM

(75) Inventor: Brian James Smith, Colorado Springs, CO (US)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/545,546

(22) Filed: Aug. 21, 2009

(51) Int. Cl. G06F 7/00

(52) U.S. Cl. 701/33

(57) ABSTRACT

In one embodiment, a vehicle prognostic and diagnostic system comprises: a vehicle maintenance computer (VMC) for prognosis and diagnosis of faults; a vehicle operations network (VON) providing a communications link between the VMC and vehicle related processors; sensors communicatively coupled to the VON providing sensor data relating to operations of vehicle sub-systems; a vehicle maintenance database communicatively coupled to the VMC providing vehicle maintenance information to the VMC; a transceiver coupled to the VMC, the transceiver selecting at least one data link from a plurality of data links for communication with a ground station. The VMC detects when a fault occurs or is likely to occur based on sensor data and the vehicle maintenance data. The VMC queries the database for mitigating action when it detects a fault occurs or is likely to occur. The transceiver uploads a message to the ground station when the database cannot provide mitigating action.

### BACKGROUND

Vehicles are susceptible to failure while in use. Such failures can be dangerous when they occur in heavy traffic, or can result in stranding passengers in desolate or dangerous locations. Unexpected failures can add costs and inconvenience to businesses and private owners. If pre-conditions to failures are detected and the vehicle is serviced, the repair may be at a lower cost to both owner and manufacturer. Therefore, eliminating or reducing such failures is desirable.

Some vehicles have the ability to collect fault information relating to the vehicle's subsystems, but do not have the ability to mitigate a potential failure. The fault information is generally not available for diagnosis except at a service location. Some existing commercial services leverage domestic cellular phone networks to enable specially equipped automobiles the ability to send fault information to a diagnostic center. However, this service only works when the vehicle is within cellular range. Further, these existing systems are limited in that they do not predict or mitigate faults. Also, these systems generally do not give information to the driver identifying the problem, how serious it is, or what action should be taken when a problem occurs. Instead, this information may come from some service providers by voice when the vehicle is within cell phone range.

For the reasons stated above and for other reasons stated below which will become apparent to those skilled in the art upon reading and understanding the specification there is a need in the art for improved vehicle maintenance systems.

### SUMMARY

In one embodiment, a vehicle prognostic and diagnostic system comprises: a vehicle maintenance computer (VMC) for prognosis and diagnosis of faults; a vehicle operations network (VON) providing a communications link between the VMC and vehicle related processors; sensors communicatively coupled to the VON providing sensor data relating to operations of vehicle sub-systems; a vehicle maintenance database communicatively coupled to the VMC providing vehicle maintenance information to the VMC; a transceiver coupled to the VMC, the transceiver selecting at least one data link from a plurality of datalinks for communication with a ground station. The VMC detects when a fault occurs or is likely to occur based on the sensor data and the vehicle maintenance data. The VMC queries the database for mitigating action when it detects a fault occurs or is likely to occur. The transceiver uploads a message to the ground station when the database cannot provide mitigating action.

### DRAWINGS

These and other features, aspects, and advantages are better understood with regard to the following description, appended claims, and accompanying drawings where:

FIG. 1 is block diagram of one embodiment of a vehicle comprising a vehicle maintenance system according to the present invention;

FIG. 2 is a block diagram of one embodiment of a satellite enabled vehicle maintenance system according to the present invention;

FIGS. 3 and 4 are exemplary messages outputted on a display during an electrical charging system failure according to the present invention; and

FIGS. 5A and 5B are a flowcharts of one embodiment of a method of operating a vehicle maintenance system according to the present invention.

The various described features are drawn to emphasize features relevant to the embodiments disclosed. Like reference characters denote like elements throughout the figures and text of the specification.

### DETAILED DESCRIPTION

Embodiments disclosed herein relate to an improved vehicle maintenance system providing vehicle prognostics and diagnostics. In embodiments of the present invention, a vehicle is equipped with a vehicle management system (VMS) that assesses vehicle maintenance and sensor data from one or more vehicle subsystems. The VMS collects the vehicle maintenance and sensor data and trends vehicle performance from the sensor data. Analysis of this data by the VMS allows the system to both identify existing failures (diagnostics) and provide early warning of potential vehicle failures (prognostics) to prompt preventative and mitigating action.

For example, when a prognostics trigger point is reached in the trend data, an onboard prognostics software uses data in an onboard vehicle maintenance database to see if a component of the vehicle is degrading and predict failure. Once a prediction is made, the driver is notified on a vehicle display and a maintenance message file is queued for delivery to a centralized ground diagnostics and prognostics system via a data link.

In one embodiment, when the VMS can not identify the error or make a prediction, a maintenance message is created and uploaded to the centralized ground system which includes a central diagnostics and prognostics system. The central diagnostics and prognostics system performs an analysis based on fleet-wide data and the maintenance message to determine a diagnosis for the fault. The analysis of the central diagnostics and prognostics system is downloaded to the VMS where it is used as described in greater detail below. Because the central diagnostics and prognostics system utilizes fleet-wide data from multiple vehicles, it can identify adverse trends in vehicle performance and determine potential corrective actions that the VMS would not be able to identify based on single-vehicle data alone. In either case of the VMS system identifying or predicting a fault or not being able to perform the identification, data sent to the ground diagnostics and prognostics system is used to update ground specific vehicle and vehicle fleet databases and models to improve future diagnostics and predictions. Additionally, the VMS can function autonomously from the ground diagnostics and prognostics system so that the driver is alerted and can make informed decisions in cases when communication may not be possible.

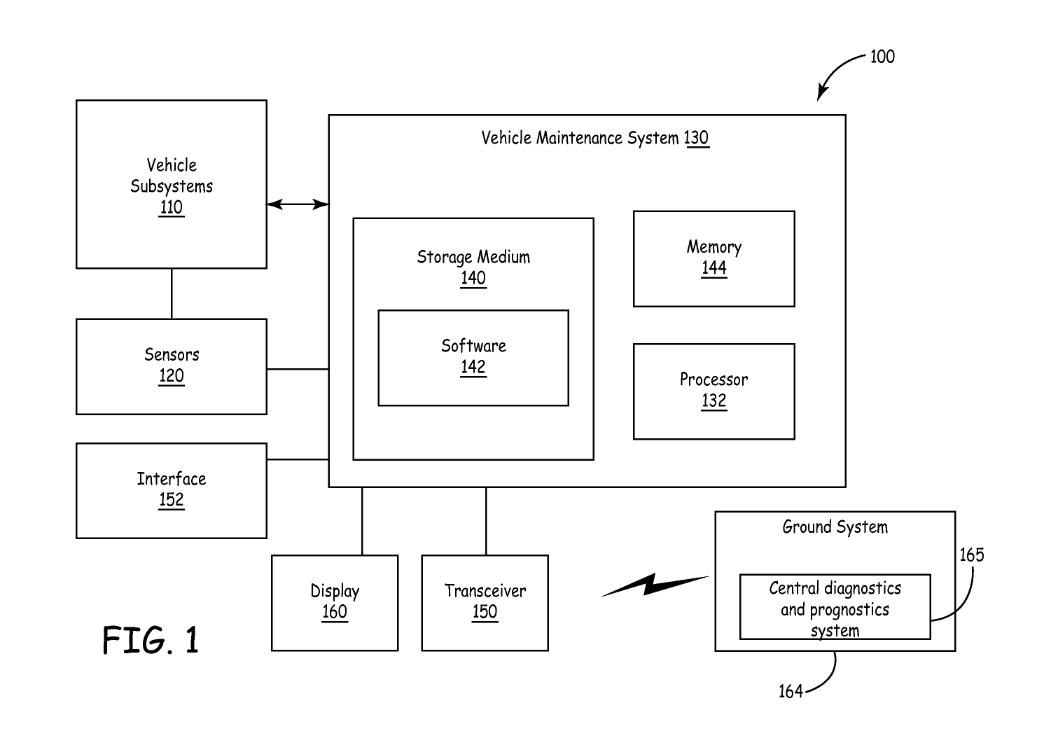

FIG. 1 is block diagram of one embodiment of a vehicle 100 comprising a vehicle maintenance system 130 according to the present invention. Vehicle 100 is not limited to any one particular type of vehicle. In alternate embodiments, vehicle 100 may include transportation devices such as including, but not limited to, automobiles, motorcycles, busses, trucks, boats, trains, tractors, robotic devices, and aircraft. Vehicle 100 may be a commercial or military vehicle. The vehicle maintenance system (VMS) 130 is an intelligent vehicle diagnostic and prognostic system. VMS 130 collects prognostic and diagnostic data relating to a plurality of vehicle subsystems 110.

Vehicle subsystems 110 includes components related to vehicle operations such as engine and drive-train systems, electrical systems, passenger cabin environmental, control and annunciation systems, brake and steering related systems, or any other system on vehicle 100. Vehicle subsystems 110 are communicatively coupled to or comprise one or more sensors 120 which monitor and collect data pertaining to vehicle subsystem 110. Sensors 120 detect operating conditions and parameters related to vehicle subsystems 110. This data (also referred to herein as vehicle maintenance information) is provided by sensors 120 to vehicle maintenance system 130. Examples of operating condition and parameter data that sensors 120 may provide to the VMS 130 include engine cylinder pressures and temperatures, fuel consumption, analysis of exhaust contents, engine rotations per minute (rpm), engine cooling system temperatures and levels, oil pressure, electrical system parameters such as operating and standby currents drawn by electrical components, and transmission parameters.

The VMS 130 comprises a processor 132, software 142, and a memory 144. The processor 132 executes the software 142. Software 142 comprises program instructions that are stored on a suitable storage device or medium 140 and include diagnostics and prognostics software for carrying out the functions of the VMS as described herein. For example, software 142 provides instructions to processor 132 for computing trends in the data received from sensors 120. Historical sensor data from sensors 120, as well as previous computations and decisions made by VMS 130, are stored in the memory 144 coupled to processor 132. For example, the VMS 130 monitors current and voltage, over the runtime of vehicle 100, and these values are stored in memory 144 as historical data (that is, trend data). This historical data is used by software 142 to determine trends of the sensor data. If a trigger point is reached, or the trend predicts a trigger point will be reached, VMS 130 concludes a fault has occurred or is imminent. The components of VMS 130 are communicatively coupled to one another as needed using suitable interfaces and interconnects. In addition, as described in greater detail below, in one embodiment VMS 130 reconfigures one or more components in vehicle subsystems 110 in order to prevent, or at least delay, a failure predicted by VMS 130.

Vehicle 100 additionally comprises a transceiver 150 that facilitates wireless communication between VMS 130 and ground system 164 that provides a central diagnostics and prognostics system 165. Transceiver 150 is configured to upload vehicle maintenance data, trends and histories from VMS 130 to a ground system 164 (also referred to herein as a central diagnostics and prognostics service center). In alternate embodiments, transceiver 150 may be implemented as a satellite transceiver (such as an Iridium transceiver or a Digital Broadcast Service (DBS) transceiver), a cellular transceiver, or a wireless metropolitan area network (MAN) transceiver. In embodiments where transceiver 150 is an Iridium transceiver, vehicle 100 has globally available voice and data communication services. In one embodiment, transceiver 150 is capable of providing data links to each of the different services (that is, one transceiver provides separate data links for Iridium, DBS, cellular, and wireless MAN communications). In another embodiment, the vehicle 100 comprises a transceiver for each data link service to be used.

The vehicle maintenance system 130 is configured to select a data link to utilize from the one or more available data links for communicating with ground system 164. Criteria the vehicle maintenance system 130 can use to select a data link include cost, performance requirements, availability, or the presence of a subscription. For example, if vehicle 100 is in the coverage area of a suitable cellular network, the vehicle maintenance system 130 could dynamically select the cellular data link for communications. Otherwise, a global link (such as the Iridium Satellite System) would be selected, especially if vehicle 100 is in a remote location. If the user did not subscribe to one of the possible data links, that data link could be removed from the choices of data links.

In one embodiment, vehicle 100 further comprises an interface 152 to connect VMS 130 to a computer via a wired connection to directly link to a service provider. A service provider provides maintenance service to vehicles, such as a repair or mechanic shop.

Vehicle 100 further comprises a display 160 to output messages within the passenger compartment of vehicle 100. Display 160 can be any device or group of devices for presenting visual information, such as a liquid crystal display (LCD), plasma monitor, cathode ray tube (CRT), or the like. In one exemplary embodiment, display 160 is an LCD screen affixed to a dashboard of an automobile. Display 160 outputs vehicle information to a driver, such as no problems found, fault warnings of a fault (either a potential fault or a fault which has already occurred), recommended actions, or upcoming servicing needed. Display 160 may present options for the driver to select to mitigate the fault. This feature will be described in more detail below.

Suitable storage devices or media 140 include, for example, forms of non-volatile memory, including by way of example, semiconductor memory devices (such as Erasable Programmable Read-Only Memory (EPROM), Electrically Erasable Programmable Read-Only Memory (EEPROM), and flash memory devices), magnetic disks (such as local hard disks and removable disks), and optical disks (such as Compact Disk-Read Only Memory (CD-ROM) disks). Moreover, the storage device or media 140 need not be local to the vehicle maintenance system 130. Typically, a portion of the software 142 executed by the processor 132. The memory 144 comprises, in one implementation of such an embodiment, any suitable form of random access memory (RAM) now known or later developed, such as dynamic random access memory (DRAM). In other embodiments, other types of memory are used.

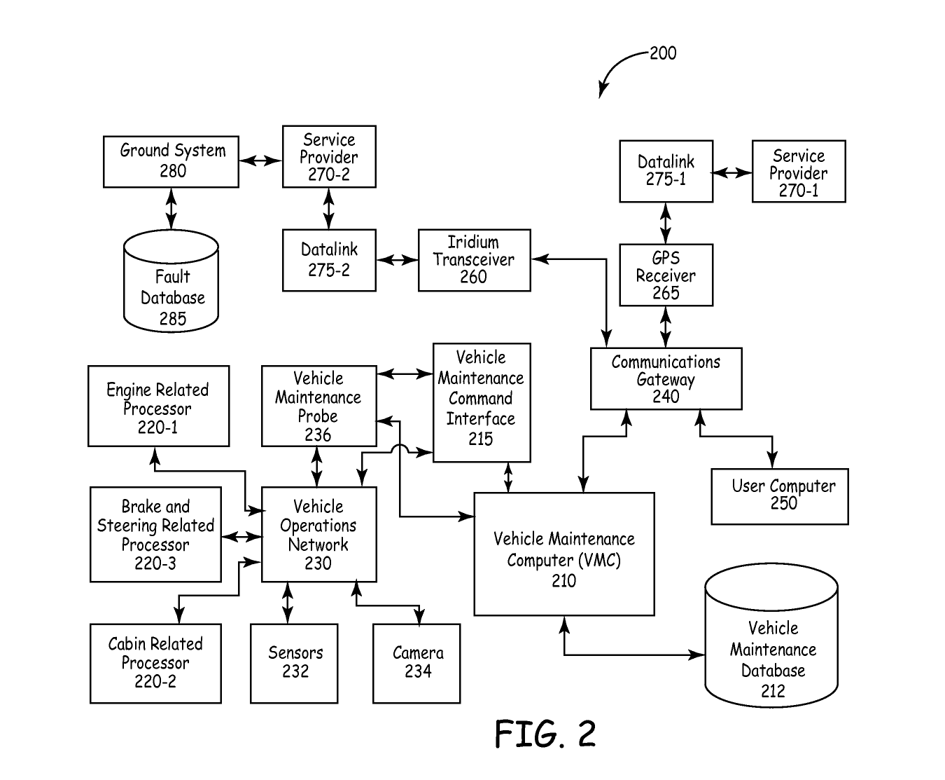

FIG. 2 is a block diagram of one embodiment of a satellite enabled vehicle maintenance system 200 according to the present invention. The VMS 200 comprises an onboard vehicle maintenance computer (VMC) 210 and a corresponding onboard vehicle maintenance database 212. The VMC 210 periodically computes averages and records resulting trend data in onboard vehicle maintenance database 212. Sensor and trend trigger points are stored in vehicle maintenance database 212. These trigger points can be remotely updated based on fleet data from a ground system 280 to improve diagnostics and prognostics. Vehicle maintenance database 212 also contains fault codes and data pertaining to solutions for a first set of faults that are of a nature that VMS 200 can diagnose and recommend corrective or preventative actions for them without external assistance. In contrast, for a second set of faults, VMS 200 cannot diagnose or recommend preventative actions and needs the support of ground system 280.

Vehicle maintenance system 200 includes an engine related processor 220-1, a cabin related processor 220-2, and a brake and steering related processor 220-3. Processors 220-1, 2 and 3 are typically included in the vehicle upon manufacture and perform a variety of tasks relating to the function of the vehicle.

Processors 220-1, 2 and 3 are communicatively coupled to VMC 210 via a vehicle operations network 230. The vehicle operations network 230 includes a communication bus that connects various vehicle subsystems together. The vehicle operations network 230 is also communicatively coupled to vehicle maintenance probe 236 and a plurality of sensors 232. Sensors 232 detect data relating to the vehicle subsystems as described with respect to sensors 120 in FIG. 1. Vehicle maintenance computer 210 taps into vehicle operations network 230 via a vehicle maintenance command interface 215. Most automobiles have a communications bus linking different components of the vehicle together that functions as the vehicle operations network 230. In embodiments where the vehicle is an automobile, the vehicle maintenance computer 210 taps directly into the vehicle communication bus.

Vehicle maintenance computer 210 is also communicatively coupled to a communications gateway 240. Communications gateway 240 is a second communication bus that links VMC 210 with other components. In the embodiment of FIG. 2, communications gateway 240 is connected to a user computer 250. User computer 250 is a computer installed in the vehicle, typically located in the passenger compartment of the vehicle. User computer 250 comprises a display for providing fault related messages to a user. The user may also select a course of action to mitigate a fault with user computer 250. Mitigating the fault may enable the vehicle to run longer or cover more distance until failure, increasing the chance that the vehicle can get to a service provider.

Communications gateway 240 links vehicle maintenance computer 210 with an Iridium transceiver 260 and a Global Positioning System (GPS) receiver 265. GPS receiver 265 receives location information from a first service provider 270-1 through a first data link 275-1. The vehicle maintenance computer 210 communicates with a second service provider 270-2 via a second data link 275-2. In one embodiment, one or both of service providers 270-1 and 270-2 connect VMC 210 to ground system 280, which provides central diagnostics and prognostics system functions.

The second service provider 270-2 links the vehicle maintenance computer 210 with the ground system 280 using the Iridium Satellite System via Iridium transceiver 260. The Iridium Satellite System provides bi-directional global coverage (including the north and south poles) for voice and data services. Although the cost of communications using Iridium transceiver 260 and the cost of the receiver itself are higher than for domestic cellular systems, coupling the vehicle maintenance computer 210 with the Iridium Satellite System provides global connection to the diagnostic, prognostic, voice, and emergency systems. Data transfer using the Iridium Satellite System is typically done in small, short bursts in order to minimize costs.

One exemplary ground system 280 is the ZING Diagnostics and Predictive Trend Monitoring (PTM) available from Honeywell International, Inc. Ground system 280 provides diagnostic and prognostic support beyond what the vehicle maintenance computer 210 onboard the vehicle provides. In one embodiment, ground system 280 comprises a fault model and vehicle data database 285 (referred to herein as a fault database). Fault database 285 stores maintenance and failure information collected directly from vehicles (that is wirelessly), information collected about vehicles at service stations and internally generated trending and analysis data. As oppose to representing information from a single vehicle, fault database 285 thus includes fleet wide vehicle information. Such data may be sorted at ground system 280 to identify data directed to a specific type of vehicle (for example, to a specific automobile make and model) or a common group of vehicles that all share common components (for example, difference vehicle models that share the same model alternator). The trending and analysis data includes statistics such as how often given fault occurs, under what conditions, and if there are common pre-conditions that typically occur which can be used to statistically predict a component failure. In alternate embodiments, a vehicle installed user computer 250 provides additional user data services, such as Internet access which can be provided by using a low bandwidth access method. Such access can be used to make phone calls, automatically request emergency service, get directions, or schedule an appointment with a service provider. Enhanced emergency service can also be provided that are capable of communicating with a global emergency service with or without human operator intervention. For example, in one embodiment, vehicle operations network 230 includes a camera 234 that can be access to transmit images on command. Sensors 232, in one embodiment, include collision sensors to detect potential collisions.

In one embodiment, communications with ground system 280 are secured. That is, vehicle maintenance computer 210 and ground station 280 or service provider 270-2 authenticate each other and protect communication with encryption (for example, using methods such as public key cryptography). These additional features add a great amount of security, safety, and reduce the likelihood of vehicle failure, especially in remote locations, and allow a single global solution to be implemented for the vehicle.

For further illustrative purposes, example scenarios are discussed below for an automobile equipped with an embodiment of the present invention as described in either FIG. 1 or FIG. 2. Examples discussed include (1) an onboard diagnostic scenario, (2) an off-board diagnostic scenario, (3) an onboard prognostics scenario, (4) an off-board prognostics scenario, and (5) a repair update scenario.

### (1) Onboard Diagnostic Scenario

The vehicle is started up and passes initial startup tests. Maintenance messages previously queued for download to the Central Diagnostics/Prognostics System (that is, the ground system) are uploaded. The VMC monitors sensor data and checks for fault codes. After the vehicle is running for several hours, a fault code for an electrical charging system failure is detected.

The VMC checks relevant sensor data on the vehicle operations network. Relevant sensor data including battery's voltage, current, and age, ambient engine compartment temperature, and the like would be collected. Diagnostics software running on the VMC considers this data and checks the vehicle's historical trend data. If the voltage is insufficient to charge the battery (for example, the voltage drops below the voltage trigger point or the battery current is not excessive and is below a current trigger point), then the fault is probably the alternator. The diagnosed failed component (alternator), fault code, time stamped related data, and current vehicle GPS location are saved in a maintenance message file and queued for immediate upload to a ground system. This data may assist service providers in repairing the failure.

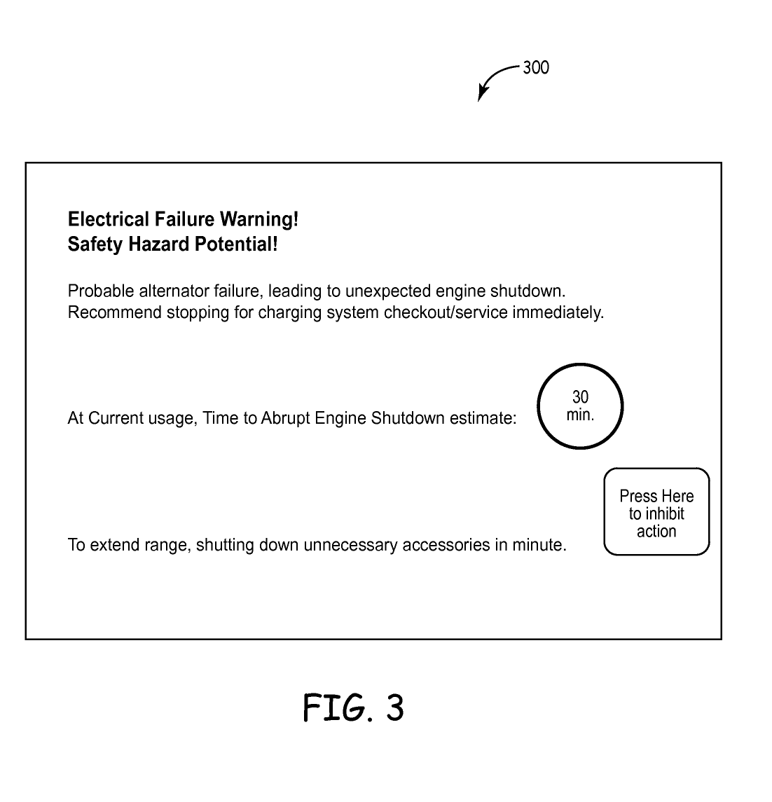

If the engine shuts down while the vehicle is moving, this component failure could have serious safety consequences. In order to reduce risk of an accident, the VMC automatically disables any electrical accessories and outputs a warning message to the driver. The message may also include a time estimate to engine shutdown. The driver is able to override the accessory shutdown decision. Further, as battery current degrades, the time estimate to engine shutdown is updated. These displayed messages assist the driver in deciding what action to take. FIG. 3 is an exemplary message output 300 during an electrical charging system failure according to the present invention.

If the on-board maintenance computer cannot determine the probable cause of the fault code, the fault code, time stamped relevant data, and the current vehicle GPS position are written to a file and queued for immediate upload to the ground system. The file can be created and uploaded even if the VMC determines the cause of the fault code. The file may include a priority processing tag that places the maintenance message higher in the queue. The VMC outputs a message notifying the driver of the type of failure, potential causes, and what actions the driver should take.

If the battery voltage reaches a minimum trigger point and the vehicle has not reached a service center or is shut down improperly, a high priority alert message is sent to the ground system before engine shutdown. This alert message includes the vehicle identification, maintenance data corresponding to the vehicle's current conditions, time and updated vehicle GPS location. If the driver cannot be reached by cell phone or through the satellite connection, the ground system could dispatch a tow truck to that location.

### (2) Off-Board Diagnostic Scenario

The same fault as in the previous example occurs, but in this scenario the VMC is unable to determine what the cause is. Regardless of whether the VMC can determine a probable component failure, fault codes and related data are sent to the ground system. This data is stored in a history database for that specific vehicle in the ground system to assist in serving that vehicle. The data is also processed to update fleet wide vehicle failure trend databases for that vehicle's particular make and model.

The ground system runs diagnostics software on the maintenance data and additional information from the vehicle fleet trend data to see if a probable failed component can be found. In this example, the fleet wide vehicle data shows that the installed alternator life has been longer than expected. Given the specific vehicle maintenance data uploaded from the vehicle, it is likely that the alternator has failed. The ground system sends a message to the VMC indicating that the failed component is probably the alternator. With this information, the VMC determines whether it can reconfigure any of the vehicle components to reduce electrical load or take any mitigating action, and correspondingly updates the display.

### (3) Onboard Prognostics Scenario

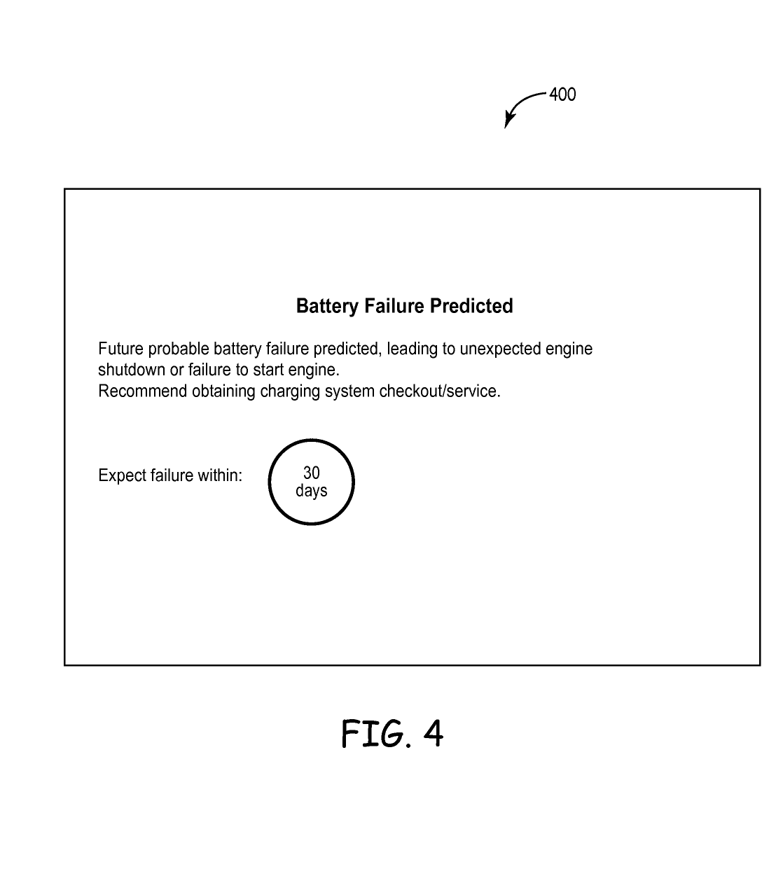

In this example, the VMC is calculating a trend in the battery current, and detects that the battery current is raising while the voltage is dropping. Once one or more of these trigger points is crossed, the VMC's prognostics software examines the battery voltage and current trend data, remaining expected battery life, and ambient temperature in an attempt to predict when a component failure would occur. In this example, the combined data suggests the battery may be developing a short circuit. The predicted battery failure, trigger points and time stamped related data are saved in a file and queued for upload. The data saved in the maintenance message will assist service providers in preventative maintenance. FIG. 4 is an exemplary message output 400 during an electrical charging system failure according to the present invention in a prognostic scenario.

### (4) Off-Board Prognostics Scenario

If the on-board maintenance computer cannot predict which component is beginning to fail, relevant time stamped data and trigger points are written to a file and queued for upload to the ground system for further analysis. The vehicle display may show that the expected time to a predicted electrical failure is unknown.

The VMC has been unable to determine a prognosis for the above described fault. A maintenance message has been sent to the ground system to determine a prognosis for a predicted failure. Ground based prognostics software is run on the data from the maintenance message combined with information from the vehicle's fleet trend data to see if a specific component failure can be predicted. If a solution is found, a response is downloaded to the VMC. The VMC takes action based on this prognosis and updates the information on the driver display. This information is also updated in the ground based history database for the particular vehicle stored in the ground system.

In this example, the fleet wide vehicle data shows that the alternator life has been less than expected and given the specific vehicle data, it is probable that the battery is failing. The ground system determines that under normal operating conditions, the remaining operational life of the battery is expected to be 80 hours. Once this information is downloaded to the VMC, the VMC updates its result, informs the driver that the battery is failing and displays the expected remaining battery life. The nominal remaining life value received from the ground system is adjusted for the vehicle's operating conditions.

### (5) Repair Update Scenario

Service technicians may have access to VMS data in the vehicle and in the central ground system to assist in repair. Once the electrical system is repaired by service technicians at a service provider, the resolution is uploaded to the ground system either by the VMC or the service provider. The ground system processes this information to refine the vehicle fleet diagnostics rules and specific vehicle history. The service technician informs the VMC, via a display or user computer, of any components that were replaced, including their part number and expected life. In this example, the technician selects the alternator component on a vehicle display maintenance page, enters the date, mileage, part number, serial number, and expected life of the alternator. This data is used for future diagnostics and prognostics. The VMC also stores this data in a file that is queued for upload to the ground system.

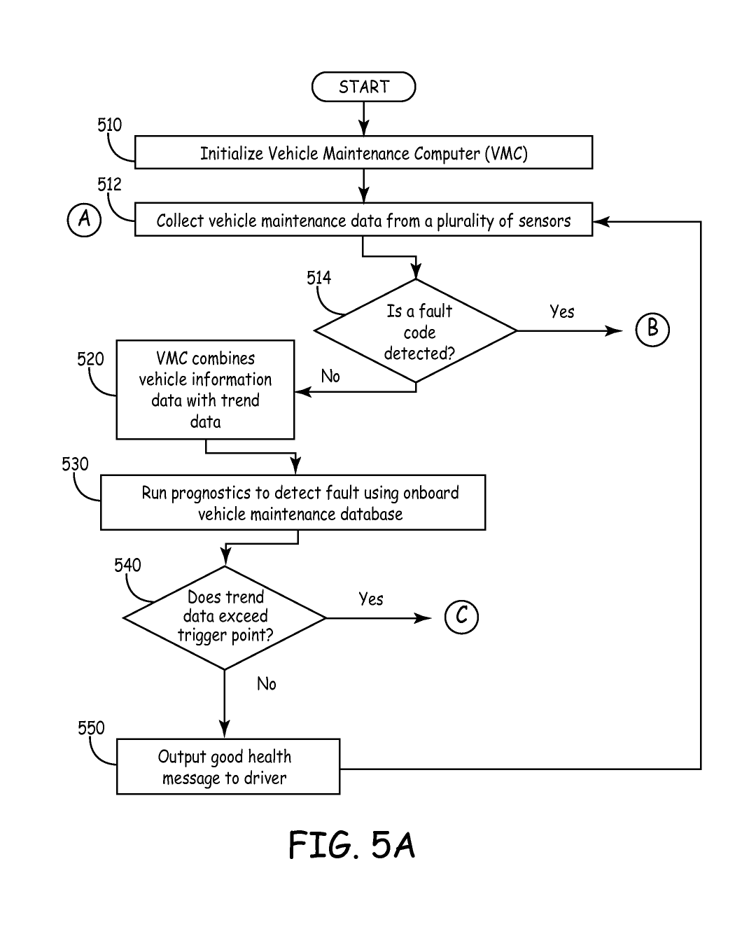

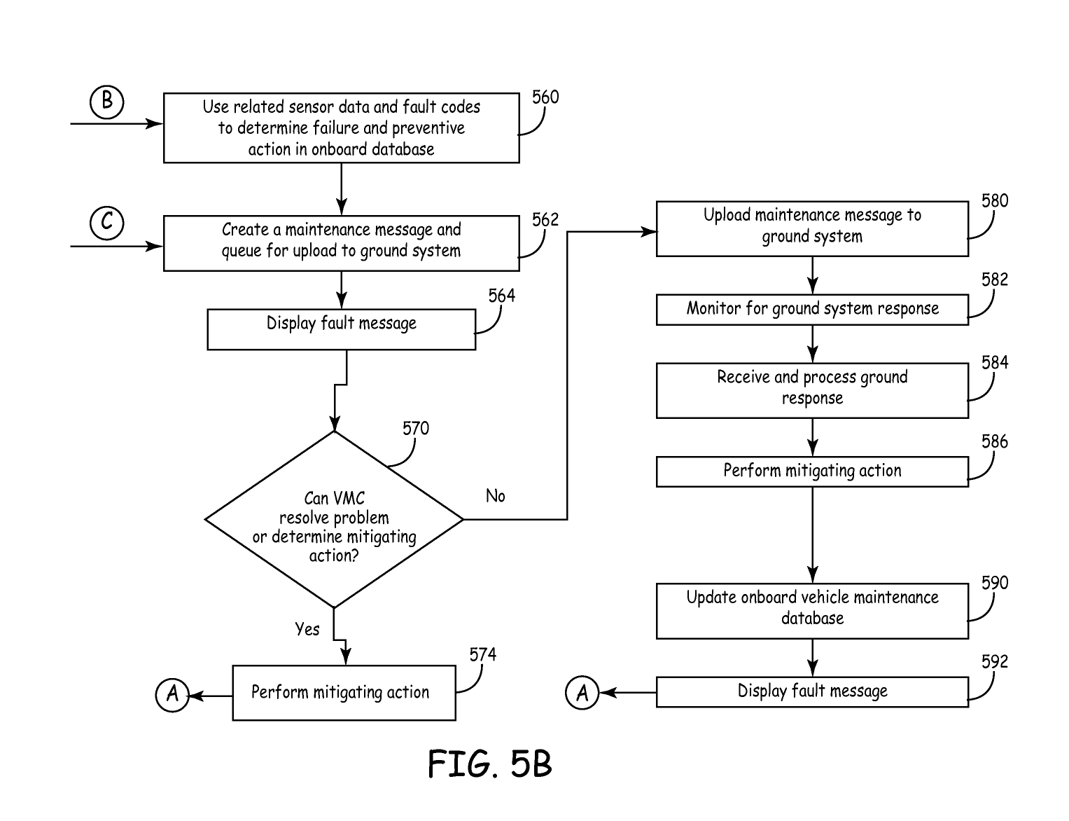

FIGS. 5A and 5B are a flowcharts of one embodiment of a method of operating a vehicle maintenance system according to the present invention. FIGS. 5A and 5B are connected at points A, B, and C. The method begins at 510 with initializing a vehicle's vehicle maintenance computer (VMC). In one embodiment, upon startup, queued maintenance messages not previously uploaded to a ground system will be uploaded using the most cost effective data link available. The VMC could defer transmission for a later attempt if the VMC is configured not to send routine data (that is, maintenance messages not pertaining to a particular fault or predicted failure) over an expensive data link.

The method proceeds to 512 with collecting vehicle maintenance data from sensors coupled to one or more vehicle sub-systems. In one embodiment, after sensor readings are obtained, the data is stored as historical data in a vehicle maintenance database. The VMC periodically obtains sensor readings from the various sensors. In one embodiment, different sensors are polled for data at different frequencies depending on the importance of the data they are collecting.

The process proceeds to 514 with evaluating sensor readings to generate fault codes. In one embodiment, the VMC also checks each sub-system to determine if sub-system level diagnostics are generating their own fault code messages. In one embodiment the VMC combines current data with data from the vehicle's history to see if any trend trigger points are present that indicate a problem. As the term is used herein, a detected fault need not represent the total functional failure of a component but instead may also represent a component that has partially degraded and exceeded some threshold but is still functional. For example, an increase in bearing vibration levels may result in the generation of a fault code before actual bearing failure occurs. Or, a fault may occur due to a sudden step-change detected in the vibration level measured by sensors.

As discussed above, a particular set of sensor readings when considered in isolation may not cause concert, but may be more significant when considered in light of historical information. Accordingly when a fault is not detected at 514, the method proceeds to 520 with combining vehicle information data with trend data. The trend data is generated by combining current sensor readings with historical data. Prognostics are run at 530 to detect a potential fault, problem, or eminent engine failure using the onboard vehicle maintenance database.

The VMC determines whether trend data exceeds a trigger point at 540. When the trend data indicate the prognostic action threshold (trigger point) is not or will not be exceeded, no mitigating action is taken. In one embodiment, a good health message is outputted to the driver indicating the vehicle is in good health (550). Alternatively, the driver can also be advised of upcoming routine services needed, such as an oil change, transmission flush, or the like based on maintenance or trending data. The VMC continues to monitor the sensor readings, calculate trends, and checks for fault codes (512).

When trend data indicates that an operating parameter exceeds a predetermined prognostics action threshold (determine at 540) the method proceeds to 562, as described below. That is, when data trends indicate that one or more prognostic action thresholds are or will be exceeded, the VCM treats the information as if a fault has been detected. The prognostic action threshold can be a trigger point, where a failure is probable once the trigger point is exceeded.

When a fault is detected (as determined at 514), the process proceeds to 560 in FIG. 5B. At 560, a mitigating action based on a detected fault is determined. In one embodiment, the VMC uses data from one or more sensors related to a fault code to look up information from the onboard vehicle maintenance database such as information that identified what the problem is or what mitigating action can be taken. As discussed above, in some cases, the VMC will be able to handle the fault without external assistance. In other cases, the VMC will require assistance from a ground system for analysis of the fault condition. Thus, in one embodiment, the vehicle maintenance database informs the VMC when a particular fault code, combination of fault codes, or sensor data requires contacting the ground system.

Using the information from the vehicle maintenance database and information relating to the fault, the method proceeds to 562 with creating a maintenance message and queuing the message for upload to a ground system (in other words, a results summary is built). The maintenance message includes information such as the fault code, related sensor data, and any actions that can be taken by the VMC or driver to mitigate the fault. A fault message is displayed at 564 that informs the driver of information relating to the fault. The method proceeds to 570 with determining if the VMC can resolve the fault or determine mitigating action (such as reprogramming a vehicle subsystem).

When the VCM knows how to resolve or mitigate the problem without consulting the ground system (determined at 570), the method proceeds to 574 with performing the mitigating action. In another embodiment, the mitigating action includes displaying a fault message to the vehicle's operator. In one embodiment, the mitigating action includes reconfiguring or reprogramming a vehicle sub-component. For example, the VCM in one embodiment will instruct the engine to adjust timing in response to a fuel system anomaly detected for an engine cylinder. The message could be a prediction (for example, fuel injector failing), recommendation to obtain service and reduce engine load (for example, shut off air conditioning, reduce speed or payload weight), advice (for example, engine performance degradation, expect less fuel mileage, engine power), or any other communication. In one embodiment, the message is outputted on a display. In another embodiment, the message conveyed is auditory. See FIGS. 3 and 4 for examples of potential display outputs and warnings provided by an embodiment of the present invention. The method continues to obtaining subsystem sensor readings (512) through point A.

When the VMC can not identify, resolve, or mitigate the fault, the method proceeds to 580 with uploading the maintenance message to the ground system using a transceiver and to 582 with monitoring for a response from the ground system. When a response from the ground system is received, the method proceeds to 584 with processing the response. Processing the response can include taking the suggested action suggested in the response, or outputting a message comprising identification of the fault and any suggested action on a display. Any mitigating action suggested by the ground response is taken at 586.

The onboard vehicle maintenance database is updated with the information from the ground system's response (590). This update ensures that information from the response will aid future analysis. Fault information is displayed to the driver (592). The method continues to obtaining subsystem sensor readings (512) through point A.

In one embodiment, a VMC writes any detected fault codes and trending data into a time stamped file (also referred to herein as a maintenance message) and queues the file for upload to the ground system. The maintenance message can also include the location of the vehicle at the time the maintenance message file was made. A vehicle identification code can also be added to the maintenance message to ensure uniqueness. Including the location of the vehicle, identification code, and time stamp enables the ground system to better determine corrective action, provide emergency services, and keep track of vehicle failures. The VMC can also perform daily averages of sensor data for a specific time period, such as hourly or daily.

The maintenance message queue can be adjusted depending on the severity of the problem (that is, a fault or prediction), safety factors relating to the problem, if a new problem is detected, or for any other reason. The queued files can be sent to the ground system at different times, such as periodically, at a predetermined time, when a fault is detected, or upon powering up of the VMC. The VMC can be pre-programmed to automatically download selected vehicle maintenance data to a service provider. The vehicle maintenance data can also be downloaded to the service provider upon user request, ground system request, or by the request of the service provider. The VMC is also configurable to respond to requests from the service provider or the user to capture maintenance data.

Embodiments of the present invention integrates an intelligent vehicle diagnostics and prognostics system, voice communications, internet access, location service, and emergency request service among other features with a satellite based system. By integrating a vehicle diagnostic system with a reasonably priced, globally available voice and data communication service, the probability of communication success and ability to get help in remote locations is greatly improved.

Additionally, this invention provides a global solution, when coupled with a globally available satellite communication service, reducing development, manufacturing, and support costs. A vehicle could be sold with this service anywhere in the world, without changes to the system. The VMS could be embedded into vehicles by their manufacturer to provide robust diagnostics and predictive prognostics. In the alternative, the VMS could be provided by a third party.

The present invention may be embodied in other specific forms without departing from its essential characteristics. Aspects and limitations described in a specific embodiment are combinable with other embodiments. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A vehicle prognostic and diagnostic system, comprising:
a vehicle maintenance computer (VMC) for prognosis and diagnosis of faults;
a vehicle operations network, wherein the vehicle operations network provides a communications link between the VMC and a plurality of vehicle related processors;
a plurality of sensors communicatively coupled to the vehicle operations network, wherein the plurality of sensors provide sensor data relating to operations of a plurality of vehicle sub-systems;
a vehicle maintenance database communicatively coupled to the VMC, wherein the vehicle maintenance database provides vehicle maintenance information to the VMC; and
a transceiver coupled to the VMC, wherein the transceiver selects at least one data link from a plurality of data links for communication with a ground station;
wherein the VMC detects when a fault occurs based on the sensor data and the vehicle maintenance data;
wherein the VMC detects when a fault is likely to occur based on the sensor data and the vehicle maintenance data;
wherein the VMC queries the vehicle maintenance database for a mitigating action when the VMC detects that either a fault occurs or a fault is likely to occur; and
wherein the transceiver uploads a maintenance message to the ground station when the vehicle maintenance database cannot provide the mitigating action.

2. The system of claim 1, wherein vehicle maintenance information comprises trend data relating to trends of the sensor data.

3. The system of claim 2, wherein the VMC detects when a fault is likely to occur based on whether trend data exceeds a threshold level.

4. The system of claim 1, wherein in response to the maintenance message uploaded to the ground station, the transceiver downloads a response from the ground station that provides fault identification information to the VMC.

5. The system of claim 4, further comprising:
wherein the response further comprises a mitigating action;
wherein the VMC performs the mitigating action.

6. The system of claim 1, further comprising:
a display coupled to the VMC, wherein the display outputs a fault message based on the mitigating action, wherein the fault message comprises at least one of a suggestion of a preventative action, a message indicating upcoming service is needed, and a message indicating the VMC is taking the mitigating action.

7. The system of claim 1, wherein the transceiver is one of a satellite transceiver, an Iridium transceiver, a cellular transceiver, a Digital Broadcast Service (DBS) transceiver, and a wireless metropolitan area network (MAN) transceiver.

8. A method of vehicle prognostics and diagnostics, comprising:
collecting vehicle maintenance data from a plurality of sensors, wherein each of the plurality of sensors monitors at least one of a plurality of vehicle systems;
combining vehicle maintenance data with trend data stored in a memory, wherein the trend data is derived from previously collected vehicle maintenance data;
processing the vehicle maintenance data to determine when a fault has occurred;
processing the vehicle maintenance data with the trend data to determine when a trigger point is exceeded;
querying the vehicle maintenance database for a mitigating action to take when the vehicle maintenance data indicates either that the fault has occurred or the trigger point is exceeded;
when querying the vehicle maintenance database does not provide the mitigating action, querying a ground station for the mitigating action, wherein querying the ground station includes creating a maintenance message comprising information related to at least one of the fault and the exceeded trigger point, uploading the maintenance message to the ground station and receiving a response from the ground station; and
performing the mitigating action.

9. The method of claim 8, wherein processing the vehicle maintenance data to determine when a fault has occurred further comprises:
identifying a fault code associated with the fault that has occurred.

10. The method of claim 8, wherein processing the vehicle maintenance data with the trend data to determine when a trigger point is exceeded further comprises:
calculating at least one trend based on the vehicle maintenance data; and
detecting when a trigger point for the at least one trend indicates the first fault is likely to occur.

11. The method of claim 8, further comprising:
outputting a health message on a display based on detection of faults and exceeded trigger points.

12. The method of claim 8, further comprising:
monitoring at least one of a plurality of data links for the response from the ground station.

13. The method of claim 8, further comprising:
outputting a fault message on a display located within a passenger compartment of a vehicle.

14. The method of claim 13, further comprising:
wherein the fault message presents to a user an option to mitigate the fault;
wherein performing the mitigating action to take in response to the fault when the vehicle maintenance database provides a mitigating action to take in response to the fault further comprises performing the mitigating action to take in response to the fault only when the user selects the option to mitigate the fault;
wherein performing the mitigating action to take in response to the exceeded trigger point when the vehicle maintenance database provides a mitigating action to take in response to the exceeded trigger point further comprises performing the mitigating action to take in response to the exceeded trigger point only when the user selects the option to mitigate the fault; and
wherein performing the mitigating action to take in response to at least the fault or the exceeded trigger point further comprises performing the mitigating action to take in response to at least the fault or the exceeded trigger point only when the user selects the option to mitigate the fault.

15. The method of claim 8, wherein uploading the maintenance message further comprises uploading the data using an Iridium transceiver.

16. The method of claim 8, wherein uploading the maintenance message further comprises:
selecting a first data link from a plurality of data links for transmitting based on predetermined criteria; and
transmitting the data over the first data link.

17. A vehicle prognostic and diagnostic system, comprising:
a vehicle, comprising:
a vehicle maintenance computer configured to determine at least one of when a fault has occurred and a trigger point has been exceeded based on vehicle maintenance data and trend data;
one or more vehicle sub-system processors;
one or more vehicle sensors communicatively coupled to the vehicle maintenance computer, wherein the one or more vehicle sensors detect the sensor data related to the one or more vehicle sub-system processors;
a vehicle maintenance database communicatively coupled to the vehicle maintenance computer, wherein the vehicle maintenance database stores vehicle maintenance data;
at least a first transceiver;
when the vehicle maintenance computer determines at least one of when a fault has occurred and a trend exceeds a trigger point, the vehicle maintenance computer determines a mitigating action to take; and
a ground system configured to receive a maintenance message comprising the vehicle maintenance information when the vehicle maintenance computer can not determine a mitigating action to take.

18. The system of claim 17, wherein the at least the first transceiver selects a data link for communicating with the ground system from a plurality of data links based at least on one of data link availability and data link signal quality.

19. The system of claim 17, further comprising:
a vehicle operations network communicatively coupling the vehicle maintenance computer with the at least one or more vehicle sensors;
wherein the first transceiver is an Iridium transceiver;
a second transceiver; and
a display for presenting the mitigating action to a user.

20. The system of claim 17, further comprising:
wherein the ground system compares the vehicle maintenance information to fleet-wide data and determines a preventative action to take;
wherein at least the first transceiver receives information relating to the preventative action; and
wherein the vehicle maintenance system performs the preventative action.
